(19) United States
(12) Patent Application Publication
(10) Pub. No.: US 2022/0087894 A1
(43) Pub. Date: Mar. 24, 2022

(54) HAND-HELD MASSAGE DEVICE WITH MULTI-MODE OF ACTION

(71) Applicant: New Era AI Robotic Inc., Taipei City (TW)

(72) Inventors: Ting-Shuo CHEN, Taipei City (TW); Po-Chun CHIA, Taipei City (TW)

(21) Appl. No.: 17/096,558

(22) Filed: Nov. 12, 2020

(30) Foreign Application Priority Data
Sep. 22, 2020 (CN) 202022094963.6

(51) Int. Cl. A61H 7/00; A61H 23/00

(52) U.S. Cl. CPC A61H 7/005; A61H 2201/14; A61H 2201/01; A61H 23/006

(57) ABSTRACT

A hand-held massage device includes a housing, a first turning plate, a second turning plate, an output rod, and a driving assembly. The housing includes an opening. The first turning plate is accommodated in the housing. The first turning plate has a concave-convex surface. The second turning plate is disposed between the opening and the first turning plate. The output rod is inserted in the second turning plate and rotated with the second turning plate. One end of the output rod is inserted to the opening and another end is abutted to the concave-convex surface. The driving assembly is connected to the first turning plate and the second turning plate. The driving assembly drives the first turning plate to rotate, drives the second turning plate to rotate or simultaneously drives the first turning plate and the second turning plate to rotate.

### BACKGROUND OF THE INVENTION

### Technical Field

The technical field relates to a massage device structure, and more particularly relates to a hand-held massage device with multi-mode of action.

### Description of Related Art

People with regular exercise or poor postures are prone to muscle fatigue and soreness. Therefore, there is a hand-held massage device on the market for lightly tapping muscles or acupuncture points of the body to give massage and soothing on muscles or acupuncture points.

However, the above hand-held massage device only provides a function of tapping, and it is obviously insufficient when comparing with professional massage. Therefore, how to design a hand-held massage device with functions of tapping, pushing/kneading is the development target of the industry.

In view of the above drawbacks, the inventor proposes this disclosure based on his expert knowledge and elaborate researches in order to solve the problems of prior art.

### SUMMARY OF THE INVENTION

This disclosure provides a hand-held massage device with multi-mode of action, in which the first turning plate may drive the output rod to reciprocate, and the second turning plate may drive the output rod to move in a circular motion, so that the hand-held massage device has multiple massage modes, and the massage efficiency is improved.

In one of the exemplary embodiments, this disclosure provides a hand-held massage device with multi-mode of action including a housing, a first turning plate, a second turning plate, an output rod, and a driving assembly. The housing is provided with an opening. The first turning plate is accommodated in the housing, and the first turning plate has a concave-convex surface configured correspondingly to the opening. The second turning plate is accommodated in the housing and disposed between the opening and the first turning plate. The output rod is inserted in the second turning plate and rotated with the second turning plate, wherein one end of the output rod is inserted to and exposed from the opening and another end is abutted to the concave-convex surface. The driving assembly is detachably connected to the first turning plate and the second turning plate, and the driving assembly is driving the first turning plate to rotate, the driving assembly is driving the second turning plate to rotate or the driving assembly is simultaneously driving the first turning plate and the second turning plate to rotate.

Based on the above, the output rod penetrates (or inserts to) the second turning plate and is abutted to the concave-convex surface of the first turning plate, the driving assembly may solely drive the first turning plate to rotate, solely drive the second turning plate to rotate or simultaneously drive the first turning plate and the second turning plate to rotate. As a result, the hand-held massage device may be selectively switched between three modes of only tapping, only rubbing/kneading or both tapping and rubbing/kneading to achieve the purpose of the hand-held massage device having multiple massage modes, and the massage efficiency is improved.

### BRIEF DESCRIPTION OF DRAWINGS

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective view of the first operation status of the hand-held massage device of this disclosure.

FIG. 2 is a side view of the first operation status of the hand-held massage device of this disclosure.

FIG. 3 is a perspective view of the second operation status of the hand-held massage device of this disclosure.

FIG. 4 is a side view of the second operation status of the hand-held massage device of this disclosure.

FIG. 5 is a side view of the third operation status of the hand-held massage device of this disclosure.

FIG. 6 is a side view of the fourth operation status of the hand-held massage device of this disclosure.

FIG. 7 is a side view of the fifth operation status of the hand-held massage device of this disclosure.

FIG. 8 is a side view of the sixth operation status of the hand-held massage device of this disclosure.

FIG. 9 is a perspective view of the first operation status of the hand-held massage device of another embodiment of this disclosure.

FIG. 10 is a perspective view of the second operation status of the hand-held massage device of another embodiment of this disclosure.

FIG. 11 is a perspective view of the third operation status of the hand-held massage device of another embodiment of this disclosure.

### DETAILED DESCRIPTION OF THE PREFERRED EMBODIMENTS

In cooperation with attached drawings, the technical contents and detailed description of the invention are described thereinafter according to a number of embodiments, not being used to limit its executing scope. Any equivalent variation or modification made according to appended claims is all covered by the claims claimed by this disclosure.

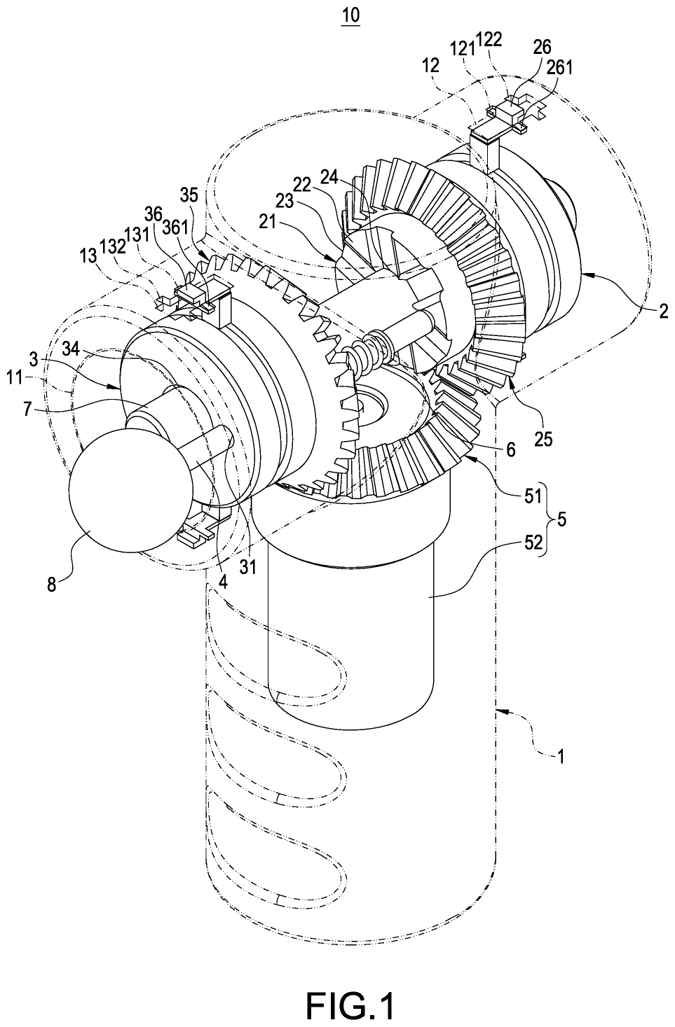

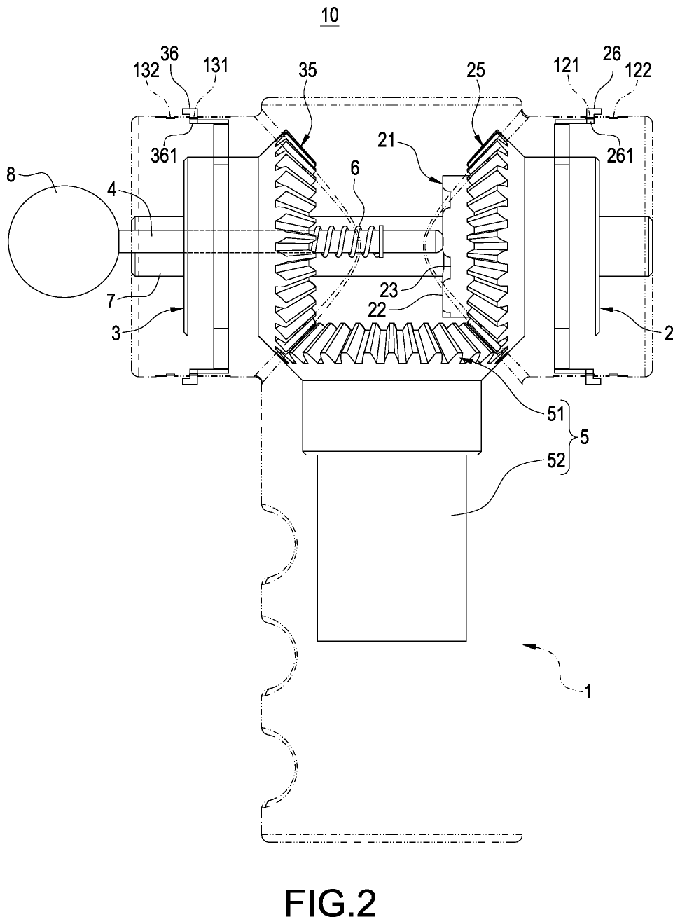

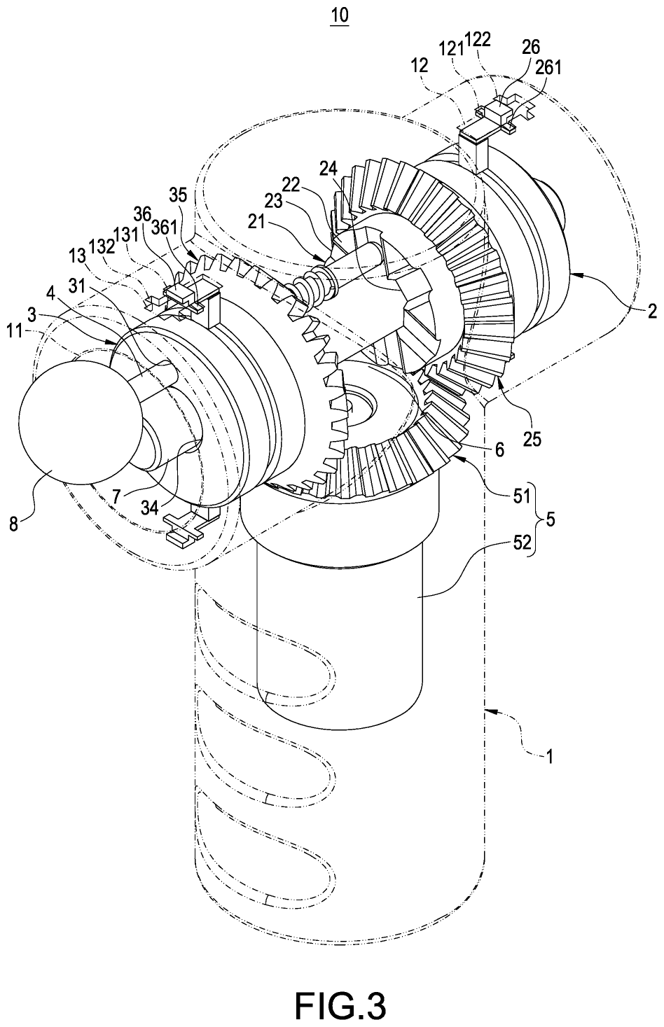

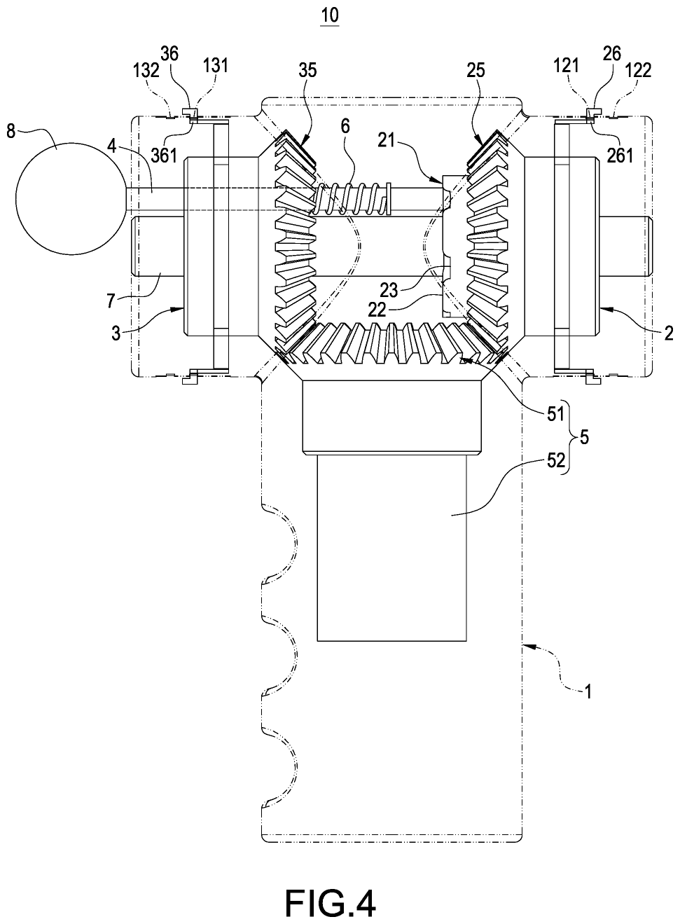

Please refer to FIG. 1 to FIG. 8, this disclosure provides a hand-held massage device with multi-mode of action. The hand-held massage device 10 includes a housing 1, a first turning plate 2, a second turning plate 3, an output rod 4 and a driving assembly 5.

As shown in FIG. 1 to FIG. 8, the front end of the housing 1 is provided (or disposed) with an opening 11. The top of the housing 1 is provided (or disposed) with one or a plurality of first hollow openings 12 and one or a plurality of second hollow openings 13. The number of the first hollow openings 12 and the second hollow openings 13 of this embodiment is two respectively, but it is not limited thereto.

The details are as follows. The inner wall of each first hollow opening 12 in the housing 12 is provided (or disposed) with a first clamping slot 121 and a second clamping slot 122. The inner wall of each second hollow opening 13 in the housing 12 is provided (or disposed) with a first inserting slot 131 and a second inserting slot 132. The first clamping slot 121 and the first inserting slot 131 are arranged (or disposed) adjacently to each other. The second clamping slot 122 and the second inserting slot 132 are arranged (or disposed) separately from each other. The first clamping slot 121 and the first inserting slot 131 are disposed at the inner sides of the top of the housing 1. The second clamping slot 122 and the second inserting slot 132 are disposed at outer sides of the top of the housing 1.

As shown in FIG. 1 to FIG. 8, the first turning plate 2 is accommodated in the housing 1, and the first turning plate 2 has a concave-convex surface configured correspondingly to the opening 11. The concave-convex surface 21 has a plurality of convex portions 22 and a plurality of concave portions 23. The convex portions 22 and the concave portions 23 are disposed circularly along an outer periphery of the first turning plate 2 and arranged staggeredly with respect to each other. The first turning plate 2 is provided (or disposed) with a first perforation 24, and an outer periphery of the first turning plate 2 has a first bevel gear 25.

Furthermore, the first turning plate 2 is extended with one or a plurality of first toggling block 26. The first toggling block 26 is penetrated through (or inserted to) and exposed from the first hollow opening 12. The first toggling block 26 is extended with a locking block 261. The locking block 261 may be selectively engaged in the first clamping slot 121 or the second clamping slot 122. The number of the first toggling block 26 of this embodiment is two, but it is not limited thereto.

As shown in FIG. 1 to FIG. 8, the second turning plate 3 is accommodated in the housing 1 and disposed between the opening 11 and the first turning plate 2. The second turning plate 3 is provided (or disposed) with a limiting hole 31 and a second perforation 34 located at one side of the limiting hole 31. An axial direction of the limiting hole 31 is disposed parallelly to an axial direction of the second perforation 34. The second turning plate 3 has a second bevel gear 35 arranged on an outer periphery thereof and disposed corresponding to the first bevel gear 25.

Moreover, the second turning plate 3 is extended with one or a plurality of second toggling block 36. The second toggling block 36 is penetrated through (or inserted to) and exposed from the second hollow opening 13. The second toggling block 36 is extended with a latch 361 The latch 361 may be selectively engaged in the first inserting slot 131 or the second inserting slot 132. The number of the second toggling block 36 of this embodiment is two, but it is not limited thereto.

As shown in FIG. 1 to FIG. 8, the output rod 4 is movably inserted to the limiting hole 31 so that the output rod 4 is inserted in the second turning plate 3 and rotated with the second turning plate 3. One end of the output rod 4 is penetrated through (or inserted to) and exposed from the opening 11 and another end of the output rod 4 is abutted to the concave-convex surface 21.

Please refer to FIG. 1 to FIG. 8, the driving assembly 5 is detachably connected to the first turning plate 2 and the second turning plate 3. The driving assembly 5 may solely drives the first turning plate 2 to rotate, solely drives the second turning plate 3 to rotate or simultaneously drives the first turning plate 2 and the second turning plate 3 to rotate.

Further explanation is as follows. The driving assembly 5 includes a driving bevel gear 51 and a motor 52. The motor 52 is connected to the driving bevel gear 51 and drives the driving bevel gear 51 to rotate. The driving bevel gear 51 may solely engage the first bevel gear 25 to rotate, solely engage the second bevel gear 35 to rotate or simultaneously engage the first bevel gear 25 and the second bevel gear 35 to rotate.

The hand-held massage device 10 of this disclosure further includes a return spring 6. The return spring 6 is elastically supported between the second turning plate 3 and a clamping point of the output rod 4. The return spring 6 is provided (or used) to drive (or take) the output rod 4 to return (or restore) in a direction approaching the concave-convex surface 21.

The hand-held massage device 10 further comprises a positioning shaft 7. The positioning shaft 7 is fixed inside of the housing 1 and inserted in the first perforation 24 and the second perforation 34. As a result, the first turning plate 2 and the second turning plate 3 rotate around the positioning shaft 7 as the center point respectively.

As shown in FIG. 1 to FIG. 8, the hand-held massage device 10 of this disclosure further includes a soft ball sleeve 8. The soft ball sleeve 8 is made of soft materials such as sponge, silicone, or rubber etc. The soft ball sleeve 8 is sleeved on one end of the output rod 4 away from the concave-convex surface 21 to enhance the comfort of the hand-held massage device 10 during massage.

As shown in FIG. 1 to FIG. 4, one mode of action of the hand-held massage device 10 of this disclosure is that when a user triggers (or toggles) the first toggling block 26 to engage the locking block 261 with the first clamping slot 121, the first turning plate 2 drives the first bevel gear 25 to engage with driving bevel gear 51. After that, when the user triggers (or toggles) the second toggling block 36 again to engage the latch 361 with the first inserting slot 131, the second turning plate 3 drives the second bevel gear 35 to engage with the driving bevel gear 51, and the return spring 6 drives the output rod 4 to abut the concave-convex surface 21 at the same time.

Thereby, the driving bevel gear 51 simultaneously drives the first bevel gear 25 and the second bevel gear 35 to rotate. When the first bevel gear 25 rotates, the plural convex portions 22 and the plural concave portions 23 move relatively to the output rod 4 and attach to the output rod 4 in a staggered manner to drive the output rod 4 to reciprocate along the axial direction of the opening 11. When the second bevel gear 35 rotates, the second turning plate 3 drives the output rod 4 to move in a circular motion along the circumference of the opening 11, so that the output rod 4 provides functions of tapping and rubbing/kneading when it contacts muscles or acupuncture points.

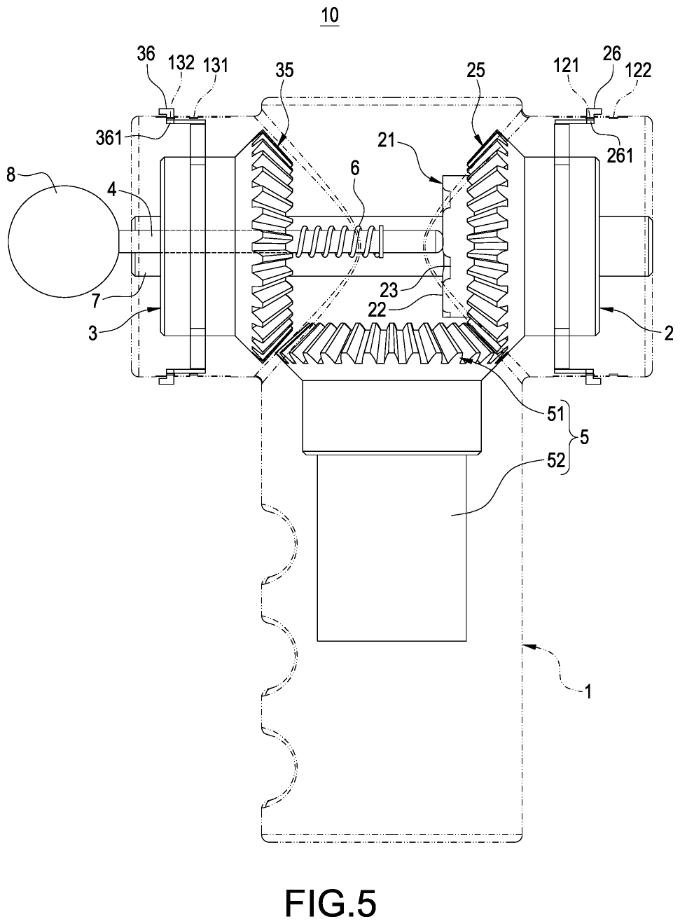

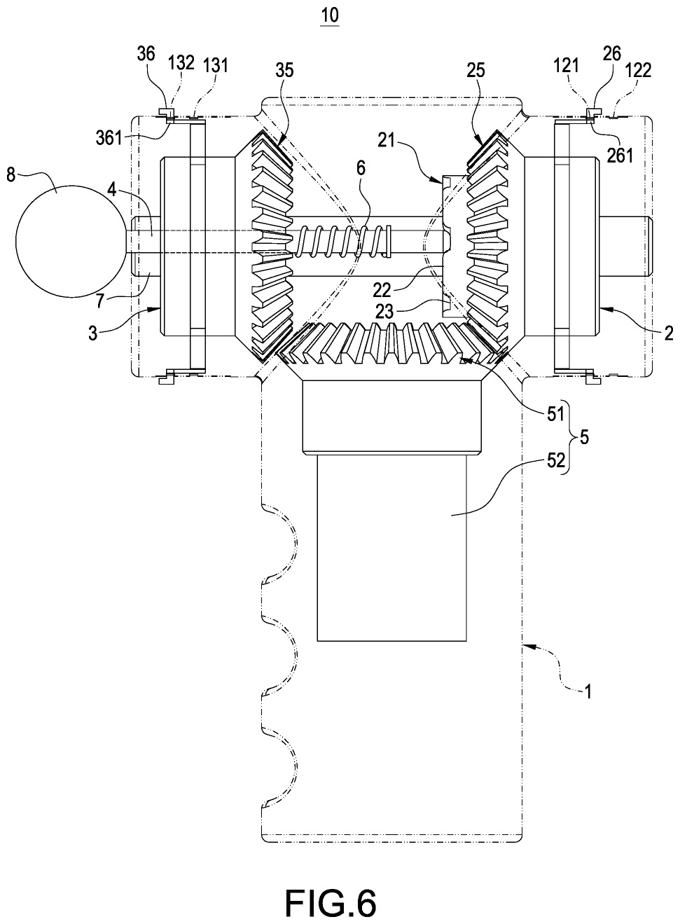

As shown in FIG. 5 and FIG. 6, another mode of action of the hand-held massager 10 of this disclosure is that when a user triggers (or toggles) the first toggling block 26 to engage the locking block 261 with the first clamping slot 121, the first turning plate 2 drives the first bevel gear 25 to engage with the driving bevel gear 51. After that, when the user triggers (or toggles) the second toggling block 36 again to engage the latch 361 with the second inserting slot 132, the second turning plate 3 drives the second bevel gear 35 to disengage from the driving bevel gear 51, and the return spring 6 drives the output rod 4 to abut the uneven surface 21 at the same time.

Thereby, the driving bevel gear 51 only drives the first bevel gear 25. When the first bevel gear 25 rotates, the plural convex portions 22 and the plural concave portions 23 move relatively to the output rod 4 and attach to the output rod 4 in an alternate manner to drive the output rod 4 to reciprocate along the axial direction of the opening 11. In addition, the second bevel gear 35 does not rotate, so that the output rod 4 only provides a function of tapping when it contacts muscles or acupuncture points.

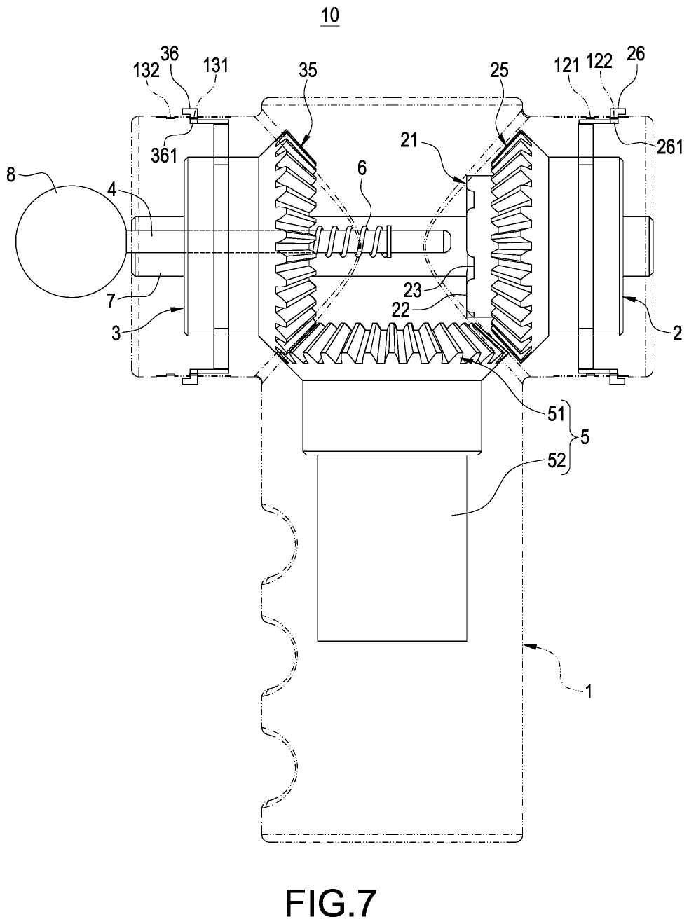

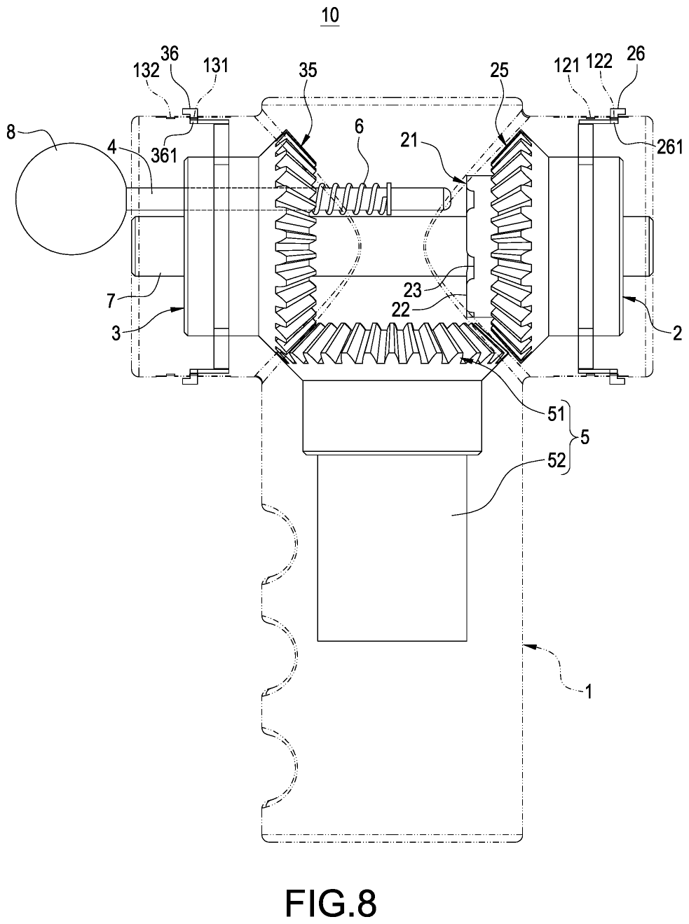

As shown in FIG. 7 and FIG. 8, a further mode of action of the hand-held massage device 10 of this disclosure is that when a user triggers (or toggles) the first toggling block 26 to engage the locking block 261 with the second clamping slot 122, the first turning plate 2 drives the first bevel gear 25 to disengage from the driving bevel gear 51. After that, when the user triggers (or toggles) the second toggling block 36 again to engage the latch 361 with the first inserting slot 131, the second turning plate 3 drives the second bevel gear 35 to engage with the driving bevel gear 51. The position where the first bevel gear 25 is disengaged from the driving bevel gear 51 is farther than the position where the return spring 6 drives the output rod 4 to return (or restore). Thus, the output rod 4 does not abut the concave-convex surface 21, and the output rod 4 is separated from the concave-convex surface 21.

Thereby, the driving bevel gear 51 only drives the second bevel gear 35 to rotate, and the first bevel gear 25 does not rotate. Furthermore, when the second bevel gear 35 rotates, the second turning plate 3 drives the output rod 4 to move in a circular motion along the circumference of the opening 11, so that the output rod 4 only provides the function of rubbing/kneading when it contacts muscles or acupuncture points.

Therefore, the output rod 4 penetrates the second turning plate 3 and is abutted to the concave-convex surface 21 of the first turning plate 2, and the driving assembly 5 may solely drive the first turning plate 2 to rotate, solely drive the second turning plate 3 to rotate or drive the first turning plate 2 and the second turning plate 3 to rotate at the same time. The hand-held massage device 10 may be selectively switched between three modes of only tapping, only rubbing/kneading or both tapping and rubbing/kneading. Thus, the hand-held massage device 10 has multiple massage modes to improve massage efficiency.

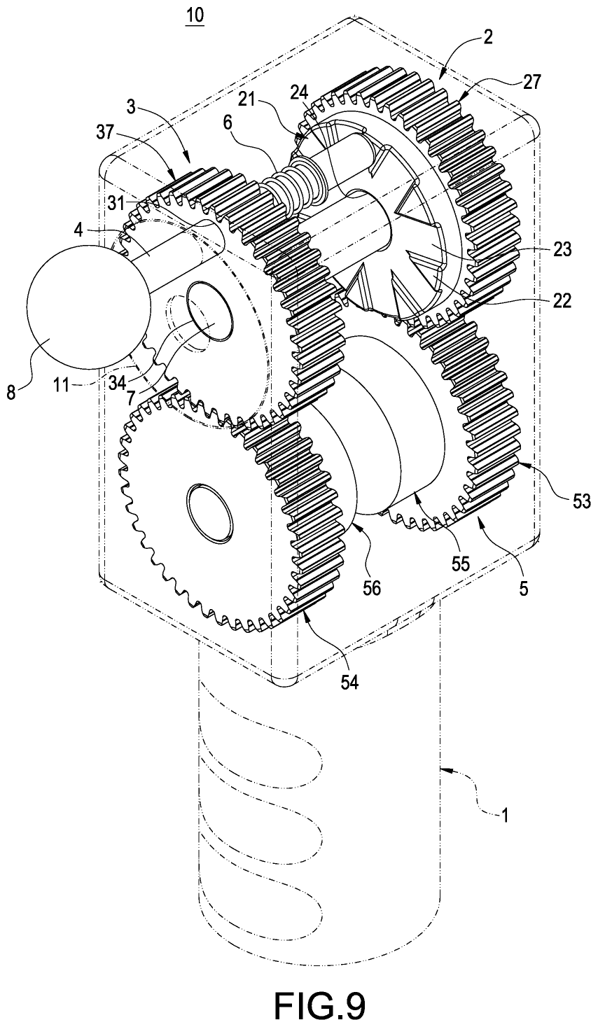

Please refer to FIG. 9 to FIG. 11, another embodiment of the hand-held massage device 10 of this disclosure is illustrated. The embodiment of FIGS. 9 to 11 is substantially the same as the embodiment of FIGS. 1 to 8. The difference between the embodiment of FIGS. 9 to 11 and the embodiment of FIGS. 1 to 8 is that the components of the driving assembly 5 are different.

The details are as follows. An outer periphery of the first turning plate 2 has a first ring gear 27, and an outer periphery of the second turning plate 3 has a second ring gear 37. The driving assembly 5 includes a first driving gear 53, a second driving gear 54, a first motor 55 and a second motor 56. The first motor 55 is connected to the first driving gear 53 and drives the first driving gear 53 to rotate. The second motor 56 is connected to the second driving gear 54 and drives the second driving gear 54 to rotate. The first driving gear 53 engages with the first ring gear 27, and the second driving gear 54 engages with the second ring gear 37.

Moreover, the return spring 6 of this embodiment is provided (or used) to drive the output rod 4 to return a position of abutting the concave-convex surface 21, so the output rod 4 continuously abuts the concave-convex surface 21.

As shown in FIG. 9, one mode of action of the hand-held massage device 10 of this disclosure is to utilize one of the first driving gear 53 and the second driving gear 54 to rotate forwardly and the other to rotate reversely for the first ring gear 27 and the second ring gear 37 rotating in different directions. Thereby, when the rotating directions of the first ring gear 27 and the second ring gear 37 are different, the plurality of convex portions 22 and the plurality of concave portions 23 move relatively to the output rod 4 and attach to the output rod 4 in a staggered manner to drive the output rod 4 to reciprocate along the axial direction of the opening 11. When the second ring gear 37 rotates, the second turning plate 3 drives the output rod 4 to move in a circular motion along the circumference of the opening 11, so that the output rod 4 provides functions of tapping and rubbing/kneading at the same time when it contacts muscles or acupuncture points.

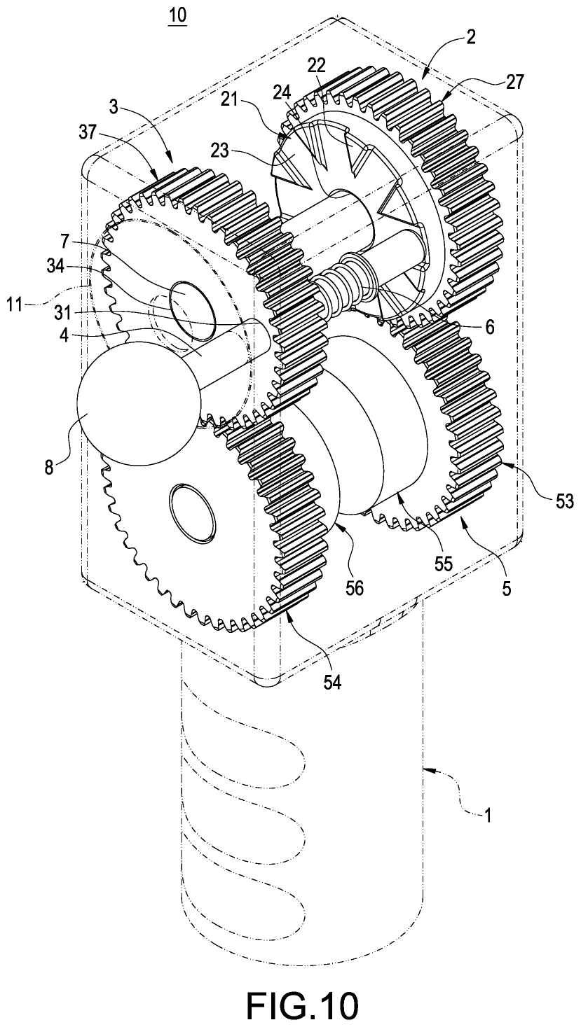

As shown in FIG. 10, another mode of action of the hand-held massage device 10 of this disclosure is to utilize the first driving gear 53 and the second driving gear 54 to simultaneously rotate forwardly at a constant speed or to simultaneously rotate reversely at a constant speed for the first ring gear 27 and the second ring gear 37 rotating in the same direction at a constant speed. Thereby, when the first ring gear 27 and the second ring gear 37 rotate in the same direction at a constant speed, the first turning plate 2 does not rotate relatively to the output rod 4, that is, the plural convex portions 22 and the plural concave portions 23 do not move relatively to the output rod 4. When the second ring gear 37 rotates, the second turning plate 3 drives the output rod 4 to move in a circular motion along the circumference of the opening 11, so that the output rod 4 only provides a function of rubbing/kneading when it contacts muscles or acupuncture points.

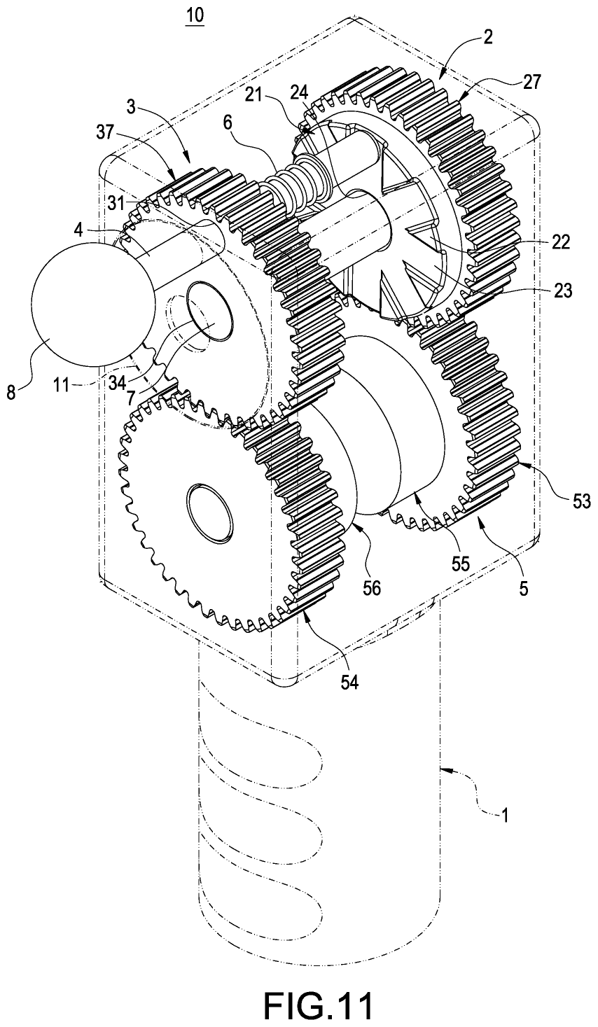

As shown in FIG. 11, a further mode of action of the hand-held massage device 10 of this disclosure is to utilize the first driving gear 53 to rotate and the second driving gear 54 not to rotate such that the first ring gear 27 rotates and the second ring gear 37 does not rotate. Thereby, when the first ring gear 27 rotates relatively to the second ring gear 37, the plurality of convex portions 22 and the plurality of concave portions 23 move relatively to the output rod 4 and attach to the output rod 4 in a staggered manner to drive the output rod 4 to reciprocate along the axial direction of the opening 11. In addition, the second ring gear 37 does not rotate, so that the output rod 4 only provides a function of tapping when it contacts muscles or acupuncture points.

From the above examples shown in FIGS. 9 to 11, the skilled persons in the art should understand that, the modes of action of the hand-held massage device 10 of this embodiment may be adjusted according to its design. That is, the first driving gear 53 and the second driving gear 54 may rotate at the same time, or either one rotates and the other one is fixed. When the first driving gear 53 and the second driving gear 54 rotate at the same time, the rotating directions may be the same or opposite, and the rotating speed may be the same or different. With the adjustments, the output rod 4 may provide the functions of tapping and rubbing/kneading at the same time, or provide either the function of tapping or the function of rubbing/kneading. In addition, the frequency of the tapping and/or the operating speed of the rubbing/kneading may be varied with the adjustments.

Although the present invention has been described with reference to the embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A hand-held massage device with multi-mode of action, the hand-held massage device comprising:
a housing, comprising an opening;
a first turning plate, accommodated in the housing and comprising a concave-convex surface configured correspondingly to the opening;
a second turning plate, accommodated in the housing and disposed between the opening and the first turning plate;
an output rod, inserted in the second turning plate and rotated by the second turning plate, wherein one end of the output rod is inserted to and exposed from the opening and another end of the output rod is abutted to the concave-convex surface; and
a driving assembly, detachably connected to the first turning plate and the second turning plate, and the driving assembly driving the first turning plate to rotate, or driving the second turning plate to rotate, or simultaneously driving the first turning plate and the second turning plate to rotate.

2. The hand-held massage device with multi-mode of action according to claim 1, further comprising a return spring, wherein a limiting hole is disposed on the second turning plate; the output rod is movably inserted in the limiting hole; and the return spring is elastically supported between the second turning plate and a clamping point of the output rod.

3. The hand-held massage device with multi-mode of action according to claim 2, further comprising a positioning shaft, wherein a first perforation is disposed on the first turning plate, and a second perforation is disposed on the second turning plate; the positioning shaft is fixed in the housing and inserted in the first perforation and the second perforation; the first turning plate and the second turning plate are rotatable around the positioning shaft respectively; and an axial direction of the limiting hole is disposed parallelly to an axial direction of the second perforation.

4. The hand-held massage device with multi-mode of action according to claim 2, wherein the return spring is provided to drive the output rod to return in a direction approaching the concave-convex surface.

5. The hand-held massage device with multi-mode of action according to claim 2, wherein the return spring is provided to drive the output rod to return a position abutting the concave-convex surface.

6. The hand-held massage device with multi-mode of action according to claim 1, wherein the concave-convex surface comprises a plurality of convex portions and a plurality of concave portions disposed along an outer periphery of the first turning plate and arranged staggeredly with respect to each other.

7. The hand-held massage device with multi-mode of action according to claim 1, wherein a first bevel gear is disposed on an outer periphery of the first turning plate, and a second bevel gear is disposed on an outer periphery of the second turning plate corresponding to the first bevel gear; the driving assembly comprises a driving bevel gear and a motor, the motor is connected to the driving bevel gear and drives the driving bevel gear to rotate; and the driving bevel gear is engaged with the first bevel gear to rotate, or engaged with the second bevel gear to rotate, or simultaneously engaged with the first bevel gear and the second bevel gear to rotate.

8. The hand-held massage device with multi-mode of action according to claim 7, wherein at least one first hollow opening is disposed on the housing comprises, and a first clamping slot and a second clamping slot are disposed on an inner wall of the first hollow opening comprises; the first turning plate comprises at least one first toggling block, and the first toggling block is inserted to and exposed from the first hollow opening, and the first toggling block comprises a locking block; when the locking block is engaged in the first clamping slot, the first bevel gear is engaged with the driving bevel gear, and the output rod is abutted to the concave-convex surface; and when the blocking block is engaged in the second clamping slot, the first bevel gear is disengaged from the driving bevel gear, and the output rod is separated from the concave-convex surface.

9. The hand-held massage device with multi-mode of action according to claim 7, wherein at least one second hollow opening is disposed on the housing, and a first inserting slot and a second inserting slot are disposed on an inner wall of the second hollow opening; the second turning plate comprises at least one second toggling block, and the second toggling block is inserted to and exposed from the second hollow opening, and the second toggling block comprises a latch; when the latch is engaged in the first inserting slot, the second bevel gear is engaged with the driving bevel gear, and the output rod is abutted to the concave-convex surface; and when the latch is engaged in the second inserting slot, the second bevel gear is disengaged from the driving bevel gear, and the output rod is abutted to the concave-convex surface.

10. The hand-held massage device with multi-mode of action according to claim 1, wherein a first ring gear is disposed on an outer periphery of the first turning plate, and a second ring gear is disposed on an outer periphery of the second turning plate; the driving assembly comprises a first driving gear, a second driving gear, a first motor and a second motor; the first motor is connected to the first driving gear and drives the first driving gear to rotate; the second motor is connected to the second driving gear and driving the second driving gear to rotate; and the first driving gear is engaged with the first ring gear, and the second driving gear is engaged with the second ring gear.
